(19) United States
(12) Patent Application Publication
(10) Pub. No.: US 2018/0301273 A1
(43) Pub. Date: Oct. 18, 2018

(54) Printed Inductors for Wireless Charging

(71) Applicant: TE Connectivity Corporation, Berwyn, PA (US)

(72) Inventors: Jason Larson, San Lorenzo, CA (US); Mudhafar Hassan-Ali, Menlo Park, CA (US); Michael A. Oar, San Francisco, CA (US); Miguel A. Morales, Fremont, CA (US); Leonard H. Radzilowski, Palo Alto, CA (US); Yiliang Wu, San Ramon, CA (US); Barry C. Mathews, Fremont, CA (US)

(21) Appl. No.: 15/490,755

(22) Filed: Apr. 18, 2017

(51) Int. Cl. H01F 27/28; H01F 27/24; H01F 1/34

(52) U.S. Cl. CPC H01F 27/2804; H02J 7/025; H01F 1/342; H01F 27/24

(57) ABSTRACT

An inductor that includes an electrically conductive construct, wherein the electrically conductive construct includes a first layer having a predetermined geometry, wherein the first layer includes at least one conductive material such as a metal; and a second layer oriented parallel to the first layer, wherein the second layer includes at least one soft ferrite, and wherein the second layer is configured in a co-planar arrangement with the first layer.

### BACKGROUND OF THE INVENTION

The described invention relates in general to inductors and inductive or wireless charging, and more specifically to thin, printed inductors incorporated into wireless charging systems used for wearable applications.

Wireless charging provides a convenient, safe, and reliable way to charge and power many different types of electrical items, including smartphones, tablets, and similar devices. By eliminating the use of physical connectors and cables, wireless charging provides efficiency, cost, and safety advantages over traditional charging methodologies. From consumer electronics to hand-held industrial devices, harsh environment electronics (e.g., under water or high humidity), and heavy-duty equipment applications, wireless power maintains safe, continuous, and reliable transfer of power to ensure all varieties of devices and equipment are charged and ready for use, as needed or desired.

Wireless charging, also known as inductive charging, utilizes an electromagnetic field to transfer energy between two objects and is typically accomplished with some type of charging station or base. Energy is sent through an inductive coupling to an electrical device so that the electrical device can then use that energy to charge batteries used to power the device or to actually run the device. Induction chargers use a first induction coil to create an alternating electromagnetic field from within the charging base, and a second induction coil in the portable device takes power from the electromagnetic field and converts it back into electric current to charge the battery or run the device. The two induction coils in proximity to one another combine to form an electrical transformer.

Wireless chargers are currently being incorporated into various systems and devices that may be worn by the user thereof. Ideally, wireless chargers that are intended for wearable applications should be thin and lightweight for the sake of increasing wearability and comfort. Accordingly, there is an ongoing need for thin, lightweight inductor coils that can be used for wearable applications, wherein the inductive properties of the coils are not diminished or reduced.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first inductor is provided. This inductor includes an electrically conductive construct, wherein the electrically conductive construct includes a first layer having a predetermined geometry, wherein the first layer includes at least one conductive material such as metal; and a second layer oriented parallel to the first layer, wherein the second layer includes at least one soft ferrite, and wherein the second layer is configured in a co-planar arrangement with the first layer.

In accordance with another aspect of the present invention, a second inductor is provided. This inductor includes an electrically conductive construct, wherein the electrically conductive construct includes a first layer, wherein the first layer includes at least one ink that contains a conductive material such as a metal; a second layer oriented parallel to the first layer, wherein the second layer includes at least one ink that contains soft ferrite, and wherein the second layer is configured in a co-planar arrangement with the first layer; and a substrate onto which the first and second layers have been deposited.

In yet another aspect of this invention, a third inductor is provided. This inductor includes at least one electrically conductive construct, wherein the at least one electrically conductive construct includes a first layer, wherein the first layer includes at least one ink that contains a conductive material such as a metal; a second layer oriented parallel to the first layer, wherein the second layer includes at least one ink that contains soft ferrite, and wherein the second layer is configured in a co-planar arrangement with the first layer; and a substrate onto which the first and second layers have been deposited by screen printing, stencil printing, dispense jet printing, paste extrusion, 3D printing, or combinations thereof, wherein the substrate has been coated with a continuous layer of ink that contains soft ferrite prior to deposition of the first and second layers on the substrate.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a perspective view of a printed inductor in accordance with an exemplary embodiment of the present invention, wherein a metal layer in the form of a coil has been deposited parallel to a material containing soft ferrite.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

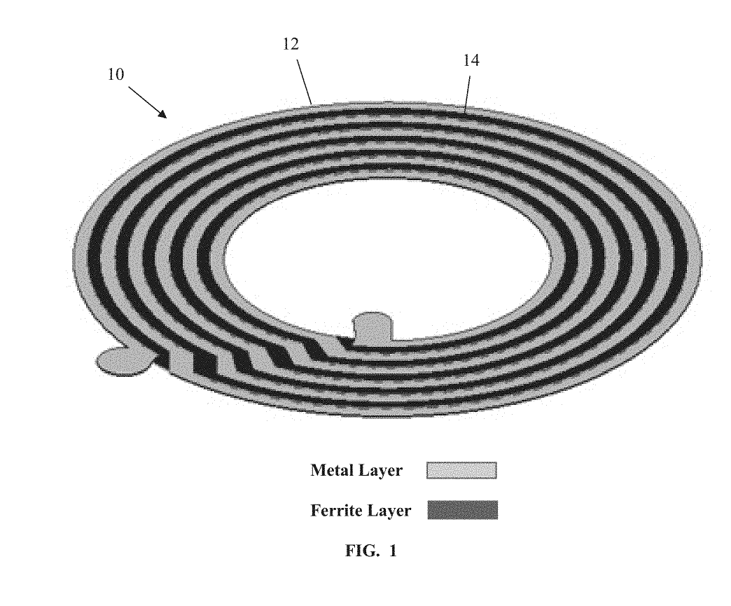

With reference to the Figure, FIG. 1 provides a perspective view of a printed inductor 10 in accordance with an exemplary embodiment of the present invention, wherein a metal layer in the shape of a coil 12 (e.g., silver) has been deposited parallel to and in a co-planar configuration with a ferrite-containing layer 14 of a predetermined size. The material of ferrite-containing layer 14 fills the gaps between the turns of coil 12. In a preferred embodiment, the conductive metal layer has an electrical conductivity greater than 1×10⁻⁶ S/m and the ferrite-containing layer has a relative permeability greater than 100. With regard to the co-planar configuration, the two materials of printed inductor 10 may be deposited in different regions of the plane to form the pattern shown in FIG. 1. The metal coil can be a constant width or varying width as needed to optimize inductance. As discussed below, certain embodiments of this invention include a substrate or “blanket” layer, which is positioned in a different plane located beneath the metal/ferrite layer. Presumably, ferrite-containing layer 14 increases overall inductance by “focusing” the direction of magnetic field lines so as to increase magnetic flux. In various embodiments of this invention, a printable ink that contains ferrite is screen or dispense jet printed to form layer 14 parallel with coil 12, which is printed using metallic ink that includes silver, copper, or a silver-tin mixture. Paste extrusion and 3D printing methods may also be used with this invention. Printable coils may be printed on a variety of substrates, over 2D or 3D topology, and with greater ease than with many other manufacturing processes. In other embodiments of the present invention, printed inductor 10 is deposited in predetermined geometries or shapes other than circular, such as oval, rectangular, or square geometries having a predetermined number of turns included therein. In some embodiments, the metal region is printed first followed by the printing of the ferrite region. In other embodiments, the ferrite region is printed first followed by the printing of the metal region.

With regard to the ferrite-containing materials used with the inductors of the present invention, in certain embodiments, the ferrites used are “soft ferrites”. Such ferrites typically contain nickel, zinc, and/or manganese compounds and exhibit low coercivity. Low coercivity indicates that magnetization of the ferrite material can easily reverse direction without significant energy dissipation (hysteresis losses), while the high resistivity of the material prevents eddy currents in its core, which are another source of energy loss. Because of their comparatively low losses at high frequencies, soft ferrites are used extensively in the cores of RF transformers and inductors. The most common soft ferrites are manganese-zinc ferrite (MnZn Fe₂O₄) and nickel-zinc ferrite (NiZn Fe₂O₄). MnZn ferrite typically exhibits higher permeability and saturation induction than NiZn ferrite, and NiZn ferrite typically exhibits higher resistivity than MnZn ferrite, and is therefore more suitable for frequencies above 1 MHz.

Prior art inductors are typically fabricated directly on printed circuit boards and then layered with sheets of ferrite material. This type of construction results in greater thickness and weight than a printed coil or layers and lacks the benefit of parallel metal and ferrite coils or layers. The printable inductors of the present invention may be created by screen printing the metallic and ferrite materials onto flexible plastic film. The ferrite inks used with this invention are formulated using particles of MnZn Fe₂O₄ or NiZn Fe₂O₄ dispersed in a polymer resin binder with an organic solvent. Table 1, below, provides three examples of the ferrite inks of the present invention. In these embodiments, the metallic (e.g., silver) layer was printed and dried, then the soft ferrite layer was printed on the same substrate and again dried. The concentration of the solvent component (e.g., diethylene glycol monoethyl ether) may be varied to optimize printability. Table 2 provides the inductance of the ferrite inks of this invention. With regard to the data presented in Table2, the ink was coated onto polyethylene terephthalate (PET) film with draw-down coater and cured at 120° C. for 30 minutes. A test coil in air demonstrated an inductance of 13.42 μH. With regard to net increases shown in Table 2, the data represents the net increase over he inductance of the test coil in air (13.42 μH).

TABLE 1
Ferrite Ink Formulations

| Example 1 | | Example 2 | | Example 3 | |
|---|---|---|---|---|---|
| Ingredient | % | Ingredient | % | Ingredient | % |
| PPT FP350 Ferrite | 75 | Steward 73321-B Ferrite | 75 | Steward 73321-B Ferrite | 78.95 |
| (NiZn Fe₂O₄) | | (MnZn Fe₂O₄) | | (MnZn Fe₂O₄) | |
| PKHH, phenoxy resin | 8 | PKHH, phenoxy resin | 8 | EpoTek 323-LP epoxy resin | 10.18 |
| Diethylene glycol | 17 | Diethylene glycol | 17 | EpoTek 323-LP | 0.35 |
| monoethyl ether | | monoethyl ether | | epoxy hardener | |
| (BP 202° C.)* | | | | Dow D.E.R. 723 | 10.52 |
| | | | | reactive diluent | |
| | 100 | | 100 | | 100 |

TABLE 2
Inductance of Ferrite Ink Formulations

| Example 1 | | Example 2 | | Example 3 | |
|---|---|---|---|---|---|
| Thickness | Inductance | Thickness | Inductance | Thickness | Inductance |
| 30.0 μm | 13.64 μH | 25.0 μm | 13.65 μH | 30 μm | 13.90 μH |
| 37.5 μm | 13.70 μH | 37.5 μm | 13.73 μH | 62 μm | 14.30 μH |
| 43.7 μm | 13.70 μH | 50.0 μm | 13.82 μH | 87 μm | 14.60 μH |
| 56.3 μm | 13.90 μH | 56.3 μm | 14.05 μH | 125 μm | 14.90 μH |

| | | | |
|---|---|---|---|
| Net 3.6% | Net 4.7% | 150 μm | 15.10 μH |

| Slope 0.009 μH/μm | Slope 0.011 μH/μm | Net 12.5% |
|---|---|---|
| | | Slope 0.011 μH/μm |

In some embodiments of this invention, silver and ferrite coils are printed onto a substrate. In some embodiments, the substrate includes polyesters, polyamides, polyimides, polycarbonates, polyketones, or combinations thereof. In other embodiments, the substrate includes polyethylene naphthalate or is configured as a flexible polyethylene terephthalate (PET) film carrier. In other embodiments, the coils are printed onto a continuous layer of ferrite ink that is first coated on the PET film carrier. The ferrite layer may also be printed on the opposite side of the PET film carrier without appreciable loss of the inductance increase, provided the thickness of the film carrier is not substantially greater than 50 micrometers. With reference to Table 3, below, inductance measurements taken on these printed structures demonstrated increased inductance compared to a printed silver coil that lacked a corresponding parallel ferrite layer. Even greater gains were observed when the coils or layers were printed on the ferrite layer. With regard to the data presented below, the test structures were screen printed on a PET film beginning with either the metal coil layer (Coils 1 and 2) or the continuous ferrite layer (Coils 3 and 4). The structures tested were 45 mm in diameter, although other diameters are possible with this invention, as are various numbers of turns in the coils and trace widths. Specific values for these parameters are determined based on particular applications for printed inductor 10. With regard to the thickness of the metal and ferrite layers or regions, various thicknesses are possible; however, the metal regions should typically not be equal to or less than the ferrite regions in thickness.

TABLE 3
Performance of Screen Printed Ag/Ferrite Inductors

| | Coil 1 | | Coil 2 | | Coil 3 | | Coil 4 | |
|---|---|---|---|---|---|---|---|---|
| Substrate | PET film | | PET film | | PET film | | PET film | |
| Printed | ESL 1908 Ag Ink | | ESL 1908 Ag ink | | Ferrite layer | | Ferrite layer | |
| layer 1 | 200 mesh screen, | | 200 mesh screen, | | (draw down | | (draw down | |
| | 50 μm thick | | 50 μm thick | | coater, 65 μm | | coater, 65 μm | |
| | emulsion (30 μm | | emulsion (30 μm | | thick print) | | thick print) | |
| | thick print) | | thick print) | | | | | |
| Printed | — | | MnZn ferrite ink | | ESL 1908 Ag | | ESL 1908 Ag ink | |
| layer 2 | | | 200 mesh screen, | | ink | | 200 mesh screen, | |
| | | | 75 μm thick | | 200 mesh screen, | | 50 μm thick | |
| | | | emulsion | | 50 μm thick | | emulsion (30 μm | |
| | | | (60 μm thick print | | emulsion (30 μm | | thick print) | |
| | | | after two passes) | | thick print) | | | |
| Printed | — | | — | | — | | MnZn ferrite ink | |
| layer 3 | | | | | | | 200 mesh screen, | |
| | | | | | | | 75 μm thick | |
| | | | | | | | emulsion | |
| | | | | | | | (60 μm thick print | |
| | | | | | | | after two passes) | |
| Inductance | 1.53 | μH | 1.55 | μH | 1.68 | μH | 1.74 | μH |
| Net | — | | 1.3% | | 9.8% | | 13.7% | |
| increase* | | | | | | | | |
| Coil | 7.9 | ohms | 8.4 | ohms | 9.9 | ohms | 9.9 | ohms |

resistance

*Increase in inductance over metal coil (i.e., Coil 1) at 100 kHz.

In summary, the materials included in various exemplary embodiments of this invention include silver flake ink; MnZn Fe₂O₄ and NiZn Fe₂O₄ powder; binder and solvent; and a PET film carrier. An exemplary method or process of this invention involves screen printing a layer of silver ink in the shape of a coil, and then screen printing ink containing a soft ferrite in a second layer that is in between and parallel to the turns of the coil. The inductance of the silver coil with and without a ferrite layer and substrate layer was measured to demonstrate effectiveness and functionality (see Tables above). The soft ferrite layer was demonstrated to increase inductance by at least 4% when combined with a ferrite bottom layer. Increasing the packing density of ferrite particles in printed ink may be used to increase the enhancement effect. Screen printing was demonstrated to give good spatial registration between coils. A dispensing system (e.g., screen printing, dispense jet printing, paste extrusion, or 3D printing) may also be utilized for printing conformally over 3D surfaces or to give thicker prints. Alternate embodiments include formulating ferrite inks with improved packing density and printing ferrite ink in open areas inside and outside of the silver coil.

In some embodiments of the present invention, multiple printed metal-ferrite inductors are stacked on top of one another and the endpoints of the metal layers included therein are electrically interconnected to form a three-dimensional inductor. The ferrite layers included therein may form a continuous phase in the stacking direction with the ferrite remaining substantially parallel to the metal. The metallic layers of each inductor do not touch each other between the individual inductors and a thin dielectric is typically included to isolate the individual inductors from one another.

While the present invention has been illustrated by the description of exemplary embodiments thereof, and while the embodiments have been described in certain detail, there is no intention to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the general inventive concept.

What is claimed is:

1. An inductor, comprising:
an electrically conductive construct, wherein the electrically conductive construct includes:
(i) a first layer having a predetermined geometry, wherein the first layer includes at least one conductive material; and
(ii) a second layer oriented parallel to the first layer, wherein the second layer includes at least one soft ferrite, and wherein the second layer is configured in a co-planar arrangement with the first layer.

2. The inductor of claim 1, further comprising a substrate onto which the first and second layers have been deposited.

3. The inductor of claim 2, wherein the first and second layers have been deposited on the substrate by screen printing, stencil printing, dispense jet printing, paste extrusion, 3D printing, or combinations thereof.

4. The inductor of claim 2, wherein the substrate has been coated with a continuous layer of ferrite ink prior to deposition of the first and second layers on the substrate.

5. The inductor of claim 2, wherein the substrate further includes polyesters, polyamides, polyimides, polycarbonates, polyketones, polyethylene terephthalate, polyethylene naphthalate, or combinations thereof.

6. The inductor of claim 1, wherein the at least one conductive material is silver, copper, or a silver-tin mixture and wherein the at least one soft ferrite includes MnZn Fe₂O₄ or NiZn Fe₂O₄.

7. The inductor of claim 1, further comprising additional electrically conductive constructs stacked on top of one another.

8. An inductor, comprising:
an electrically conductive construct, wherein the electrically conductive construct includes:
(i) a first layer, wherein the first layer includes at least one ink that contains a conductive material;
(ii) a second layer oriented parallel to the first layer, wherein the second layer includes at least one ink that contains soft ferrite, and wherein the second layer is configured in a co-planar arrangement with the first layer; and
(iii) a substrate onto which the first and second layers have been deposited.

9. The inductor of claim 8, wherein the first and second layers have been deposited on the substrate by screen printing, stencil printing, dispense jet printing, paste extrusion, 3D printing, or combinations thereof.

10. The inductor of claim 8, wherein the substrate has been coated with a continuous layer of ferrite ink prior to deposition of the first and second layers on the substrate.

11. The inductor of claim 8, wherein the substrate further includes polyesters, polyamides, polyimides, polycarbonates, polyketones, polyethylene terephthalate, polyethylene naphthalate, or combinations thereof.

12. The inductor of claim 8, wherein the at least one ink that contains a conductive material further includes silver, copper, or a silver-tin mixture.

13. The inductor of claim 8, wherein the at least one ink that includes a soft ferrite further includes MnZn Fe₂O₄ or NiZn Fe₂O₄.

14. The inductor of claim 13, wherein the MnZn Fe₂O₄ or NiZn Fe₂O₄ has been dispersed in a polymer resin binder with an organic solvent.

15. The inductor of claim 8, further comprising additional electrically conductive constructs stacked on top of one another.

16. An inductor, comprising:
at least one electrically conductive construct, wherein the at least one electrically conductive construct includes:
(i) a first layer, wherein the first layer includes at least one ink that contains a conductive material;
(ii) a second layer oriented parallel to the first layer, wherein the second layer includes at least one ink that contains soft ferrite, and wherein the second layer is configured in a co-planar arrangement with the first layer; and
(iii) a substrate onto which the first and second layers have been deposited by screen printing, stencil printing, dispense jet printing, paste extrusion, 3D printing, or combinations thereof, wherein the substrate has been coated with a continuous layer of ink that contains soft ferrite prior to deposition of the first and second layers on the substrate.

17. The inductor of claim 16, wherein the substrate further includes polyesters, polyamides, polyimides, polycarbonates, polyketones, polyethylene terephthalate, polyethylene naphthalate, or combinations thereof.

18. The inductor of claim 16, wherein the at least one ink that contains a conductive material further includes silver, copper, or a silver-tin mixture.

19. The inductor of claim 16, wherein the at least one ink that includes a soft ferrite further includes MnZn Fe₂O₄ or NiZn Fe₂O₄.

20. The inductor of claim 19, wherein the MnZn Fe₂O₄ or NiZn Fe₂O₄ has been dispersed in a polymer resin binder with an organic solvent.
